(19) United States
(12) Patent Application Publication
(10) Pub. No.: US 2019/0108309 A1
(43) Pub. Date: Apr. 11, 2019

(54) PATHOGENETIC CLASSIFICATION OF GENETIC ALTERATIONS

(71) Applicant: INTERNATIONAL BUSINESS MACHINES CORPORATION, ARMONK, NY (US)

(72) Inventors: Vanessa V. Michelini, Boca Raton, FL (US); Jia Xu, Somerville, MA (US); Fang Wang, Plano, TX (US); Claudia S. Huettner, Jamaica Plain, MA (US)

(21) Appl. No.: 15/725,489

(22) Filed: Oct. 5, 2017

(51) Int. Cl. G06F 19/22; G06F 19/24

(52) U.S. Cl. CPC G06F 19/22; G06F 19/24

(57) ABSTRACT

Embodiments of the present invention disclose a method, computer program product, and system for automatically classifying mutations using a table of knowledge in the format of a hierarchical classification table, without need for manual curation by genomics domain subject matter experts (SMEs) one at a time. A query from a user to classify a mutation is received. Mutations are matched to one or more entries in the table of known mutation classifications based on a name, a description, or a range of a gene sequence, or a combination thereof. The closest matched entry to the mutation is determined. The mutation is classified using the classification of the closest matched entry in the table.

### BACKGROUND

The present invention relates generally to the field of pathology and databases, and more particularly to gene mutation classification and gene pathogenicity.

A mutation is a permanent alteration in the DNA sequence that makes up a gene, such that the sequence differs from what is found in most people. Mutations range in size; they can affect anywhere from a single DNA building block, or base pair, to a large segment of a chromosome that includes multiple genes.

Mutations can be classified in two major ways, the first being hereditary mutations that are inherited from a parent and are present throughout a person's life in virtually every cell in the body. These mutations are also called germline mutations because they are present in the parent's egg or sperm cells, which are also called germ cells. When an egg and a sperm cell unite, the resulting fertilized egg cell receives DNA from both parents. If this DNA has a mutation, the child that grows from the fertilized egg will have the mutation in each of his or her cells.

The second major classification of gene mutations are acquired, or somatic, mutations that occur at some time during a person's life and are present only in certain cells, not in every cell in the body. These changes may be caused by environmental factors such as ultraviolet radiation from the sun or during cellular reproduction when a mistake is made as DNA copies itself during cell division. Acquired mutations in somatic cells, as in cells other than sperm and egg cells, cannot be passed on to the next generation.

### SUMMARY

Embodiments of the present invention disclose a method, computer program product, and system for automatically classifying mutations using a table of knowledge in the format of a hierarchical classification table, without need for manual curation by genomics domain subject matter experts (SMEs) one at a time. A query from a user to classify a mutation is received. Mutations are matched to one or more entries in the table of known mutation classifications based on a name, a description, or a range of the gene sequence, or a combination thereof. The closest matched entry to the mutation is determined. The mutation is classified using the classification of the closest matched entry in the table.

### BRIEF DESCRIPTION OF THE DRAWINGS

FIG. 1 is a functional block diagram illustrating a distributed data processing environment, in accordance with an embodiment of the present invention.

FIG. 2 is a functional block diagram illustrating the components of an application within the distributed data processing environment, in accordance with an embodiment of the present invention.

FIG. 3 is a flowchart depicting operational steps of a genetic classification application, on a server computer within the data processing environment of FIG. 1, in accordance with an embodiment of the present invention.

FIG. 4 is a flowchart depicting operational steps of a classification module within a genetic classification application, on a server computer within the data processing environment of FIG. 1, in accordance with an embodiment of the present invention.

FIG. 5 depicts a block diagram of components of the server computer executing the genetic classification application, in accordance with an embodiment of the present invention.

### DETAILED DESCRIPTION

Embodiments of the present invention relate to the field of computing, and more particularly to gene mutation classification and mutation pathogenicity. The following described exemplary embodiments provide a system, method, and program product to, among other things, classify mutations using a table of knowledge in the format of a hierarchical classification table, without need for manual curation by genomics domain subject matter experts (SMEs) one at a time. Therefore, the present embodiment has the capacity to improve the technical field of mutation categorization in pathology and databases by increasing the efficiency of classification of mutations and determining pathogenicity. Pathogenicity being the ability of a genetic alteration to cause disease, or the mutation in an organism responsible for giving the organism the ability to cause disease. This ability represents a genetic component of the pathogen and the overt damage done to the host is a property of the host-pathogen interactions.

It may be advantageous to automatically classify of mutations using a table of knowledge in the format of a hierarchical classification table, without need for manual curation by genomics domain subject matter experts (SMEs) one at a time. A query from a user to classify a mutation may be received. Mutations may be matched to one or more entries in the table of known mutation classifications based on amino acid change, nucleotide change, codon, highly conserved region, protein-protein interaction region and protein domain. The closest matched entry to the mutation may be determined and the mutation is classified using the classification of the closest matched entry in the table.

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when the particular feature, structure, or characteristic is described in connection with an embodiment, it is submitted that it is within the knowledge of one skilled in the art to affect such feature, structure, or characteristic in connection with other embodiments whether or not explicitly described.

Most disease-causing mutations are rare in the general population. However, benign, or pathologically neutral genetic alterations or changes occur more frequently. Genetic alterations that occur in more than 1% of the population are common enough to be considered a normal variation in the DNA.

For exemplary purposes, the below discussion of the present invention is limited to genetic mutations leading to cancer; however, it should be appreciated by those skilled in the art that the present invention may be equally applied to other genetic diseases or non-disease causing genetic mutations. In cancer, mutations are classified as benign, likely benign, pathogenic, likely pathogenic, and variants of unknown significance. Pathogenic classification may refer to a mutation driving cancer and likely pathogenic may refer to a mutation only likely to be driving cancer. Of over 20,000 genes in the human body, there are currently around 500 genes which are known to be related to cancer. Each of these genes can have infinite number mutations, from an amino acid permutation (A->G), to insertions and deletions, to gain or loss of gene copies.

An exemplary clinical scenario may be a cancer patient that has the DNA from a tumor biopsy sequenced and sent for analysis. The output genetic profile contains this patient's tumor somatic mutations. In the context of cancer pathology, the present invention describes a system and method to classify mutations within the patient's genetics as benign, likely benign, pathogenic, likely pathogenic, or variant of unknown significance based on evidence extracted from the literature in the field of oncology.

Classification of mutations may occur in several ways. Experts are hired to search for evidences, found in various publications, and curate the information in a variant centric database. The patient mutations, or variants, are compared with the ones in the database for matching. Because of the infinite number of potential mutations, the centric database may never be complete and mutations not found by searching the centric database are sent to experts for classification. The new mutations, identified by these experts are then included in the centric database for future reference. The process is labor intense and requires multiple different curators, which may lead to slight variations in classifications and further result in some bias. As new advances in research are made and published it is difficult to stay current and maintain a complete and accurate database. For example, in 2015 alone, 160,000 new articles related to cancer were published.

There are algorithms such as SIFT and Polyphen-II that predict the functional impact of whether a mutation is benign or pathogenic; however, current algorithms are not reliable and not used in the clinical setting. It would be advantageous to have a system which limits curator bias and increases classification reliability. It should be appreciated that all named products or companies are trademarks of their respective owners.

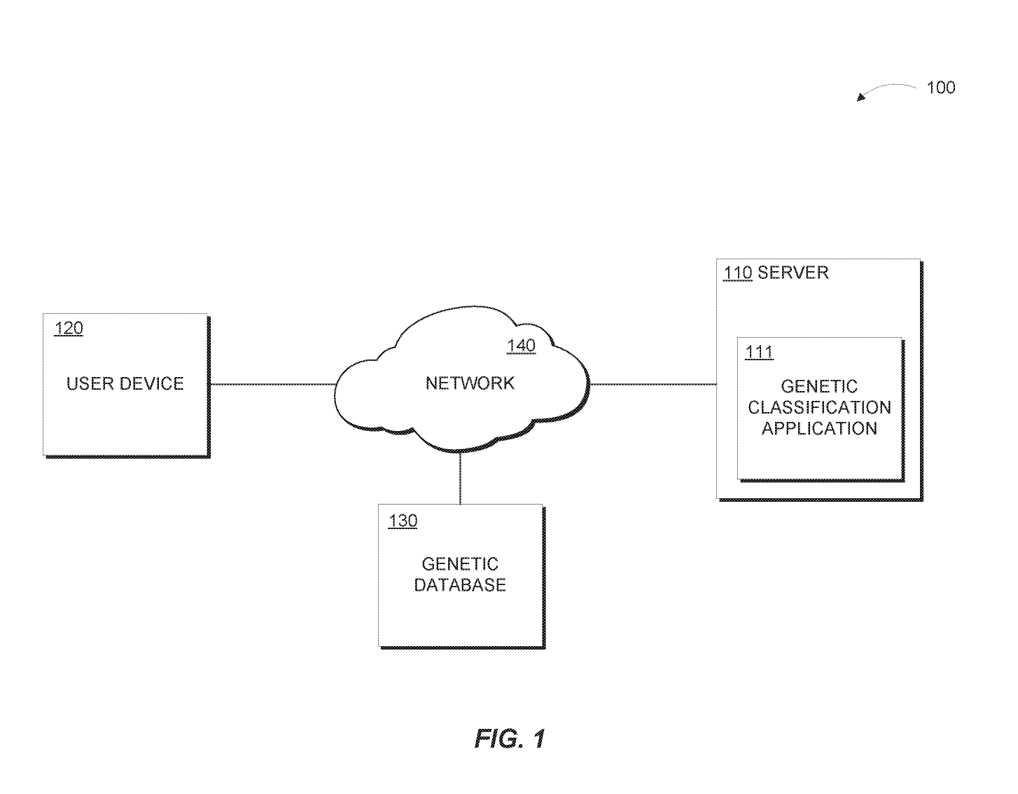

The present invention will now be described in detail with reference to the Figures. FIG. 1 is a functional block diagram illustrating a distributed data processing environment, generally designated 100, in accordance with one embodiment of the present invention.

Distributed data processing environment 100 includes server 110, user device 120, and genetic database 130, all interconnected over network 140.

Server 110 and user device 120 may be a laptop computer, tablet computer, netbook computer, personal computer (PC), a desktop computer, a smart phone, or any programmable electronic device capable of communicating with server 110, user device 120, and genetic database 130 via network 140 and with various components and devices distributed data processing environment 100. In various embodiments, server 110 may be a separate server or series of servers, a database, or other data storage, internal or external to user device 120 and genetic database 130.

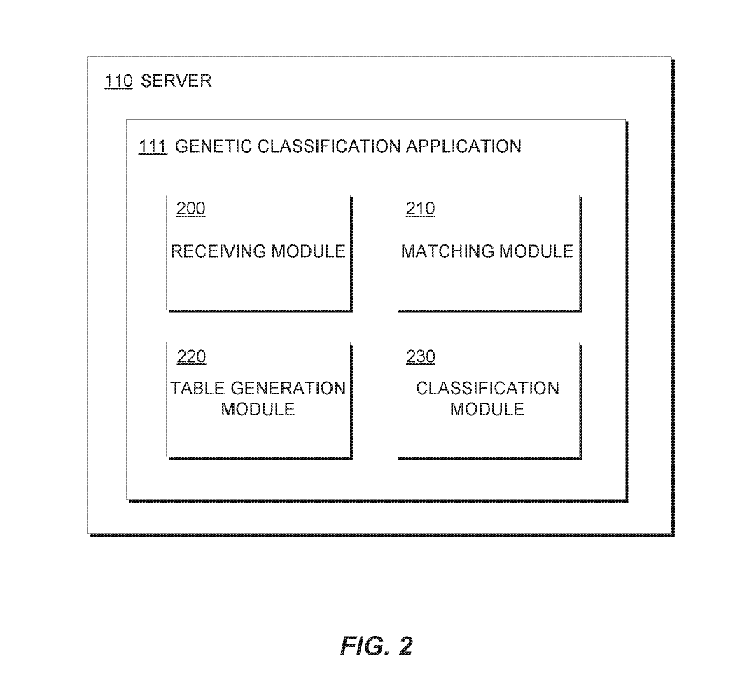

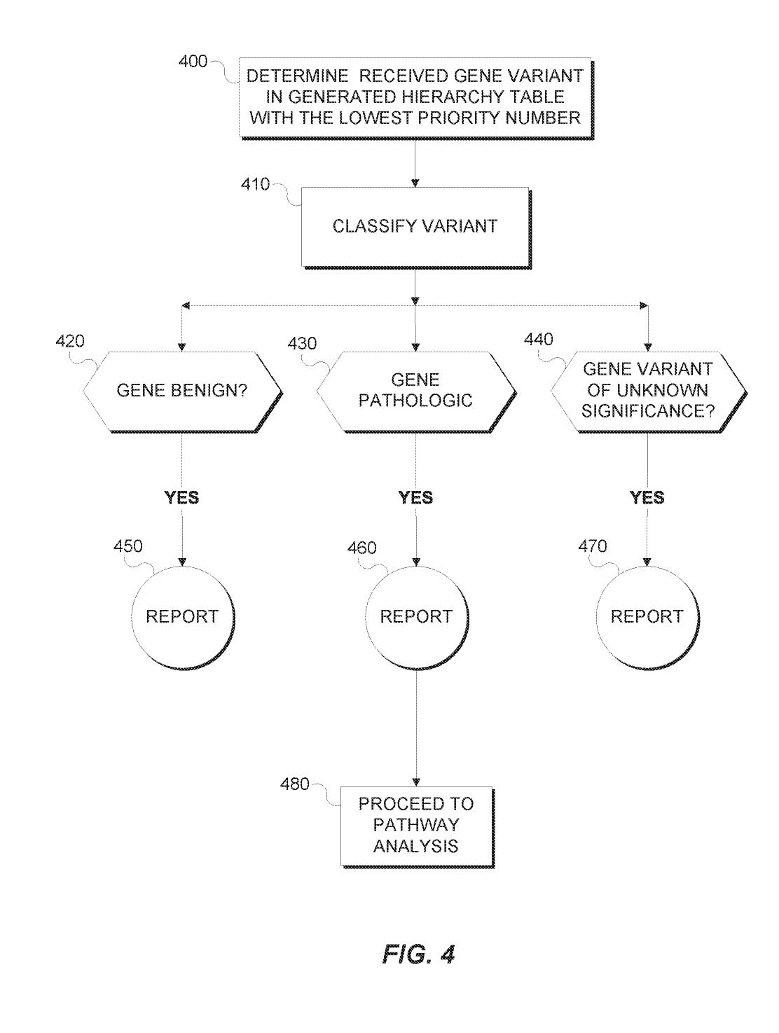

Server 110 includes genetic classification application 111, as described in more detail in reference to FIG. 2. In various embodiments, server 110 may include internal and external hardware components, as depicted and described in further detail with respect to FIG. 4.

Genetic classification application 111 may act generally to receive a gene data or table(s), for example, from genetic database 130, described in more detail below. Genetic classification application 111 may also receive one or more requests from a user, for example, via user device 120, to classify a mutation or multiple mutations. Genetic classification application 111 may match the received mutation to one or more entries in the received hierarchy table of known mutation classifications and subsequently classify the mutation based on determining which entry is the closest match to an entry in the database. In various embodiments, genetic classification application 111 may match the received mutation to one or more entries in the received hierarchy table of known mutation classifications based on, an amino acid change, nucleotide change, codon, highly conserved region, protein-protein interaction region and protein domain. The data from genetic database 130 may contain information extracted from the literature or publications. In cognitive systems, natural language processing and machine learning techniques are used to extract the information. The information may be validated by experts before loading on to genetic database 130.

Genetic database 130 may be any computer readable storage media accessible via network 140. Genetic database 130 may ingest and index received electronic documents and publications to be communicated to server 110, in accordance with an embodiment of the invention. Genetic database 130 may also be a laptop computer, tablet computer, netbook computer, personal computer (PC), a desktop computer, a smart phone, or any programmable electronic device capable of communicating with server 110, user device 120, and with various components and devices of distributed data processing environment 100, via network 140. Genetic database 130 use any ingestion methods known in the art, for example, Optical Character Recognition (OCR), Object Linking and Embedding (OLE), or ingestion of well-defined HTML tabular data.

Genetic database 130 may generate one or more hierarchy tables based on the ingested publications. Genetic database 130 may communicate the ingested genetic data to genetic classification application 111 via server 110 through network 140, according to embodiments of the present invention.

In various embodiments of the present invention, genetic database 130 may generate and format hierarchy tables based on the received and indexed electronic documents. A hierarchy table may contain columns headers representing categories of information associated with known genes and cells populated by ingested data corresponding to known genes. A hierarchy table may contain a gene column, annotation column, alteration type column, range column, hierarchy level column, hierarchy priority column, classification column, and publication source column, for example, PubMed.

The gene column is populated with a canonical or recognized name associated with the ingested gene data. Annotation column is populated by a description of the function structure of the named gene. The alteration type column is populated with the alteration type of the queried variant and represents the differences or alterations between the mutation associated with the classification query and the matched gene.

The hierarchy level column is populated based on the location of the genetic variant match. Table 1 below is a table containing an exemplary embodiment of hierarchy levels and the corresponding variant locations may be predetermined or determined by various descriptions within the indexed and ingested publications.

TABLE 1

| Priority # | Level | Genetic Variant Location |
|---|---|---|
| 1 | Variant | The exact variant is described in the literature with functional studies and |
| | | effects on protein function are reported |
| 2 | Codon | The codon affected by the mutation is described in the literature or a different |
| | | pathogenic variant located in the codon is described in literature |
| 3 | Highly Conserved | The variant is located in a highly conserved region like motifs or well- |
| | Region | characterized structures like A-loop or P-loop characterized in the literature |
| 4 | Region | The variant is in a repeat or binding region that is characterized in the literature |
| 5 | Domain | The variant is in a protein domain that is characterized in the literature |

The hierarchy priority column is based on the matched hierarchy level. The priority column is populated by the priority number corresponding to the associated level name.

The classification column is generated based on the classification of the named gene. The classification may be extracted from the literature using, for example, natural language processing and machine learning techniques. In various embodiments, the named genes and classifications are validated by experts before populating the hierarchy table.

The publication column is generated based on the reference or publication identifiers associated with the publication or literature from which the data associated with the named genes were extracted. In various embodiments, the generated hierarchy table is communicated to genetic classification application 111, as described below.

Network 140 can be, for example, a local area network (LAN), a wide area network (WAN) such as the Internet, or a combination of the two, and can include wired, wireless, or fiber optic connections. In general, network 140 can be any combination of connections and protocols that will support communications between server 110, user device 120, and genetic database 130.

FIG. 2 is a functional block diagram illustrating the components of genetic classification application 111 on server 110, within the distributed data processing environment 100, in accordance with an embodiment of the present invention. Genetic classification application 111 includes receiving module 200, matching module 210, table generation module 220, and classification module 230.

In reference to FIGS. 1 and 2, receiving module 200 may act generally to receive inputs from and/or a document or sets of documents from a device, for example, user device 120 or genetic database 130. In an embodiment of the present invention, receiving module 200 may receive ingested and indexed hierarchy tables about various genes from a database, for example, genetic database 130. Receiving module 200 may receive a classification query that includes a mutation from a device, for example, user device 120, via user input. Receiving module 200 may communicate the classification query, and associated mutation, to matching module 210.

Matching module 210 may act generally to receive classification queries from receiving module 200, receiving module 200 for mutations, and compare and match received mutations to known mutations in a database. Matching module may perform two types matching: variant matching and ranged matching. Variant matching is where an exact match is obtained and ranged matching is where the position of the mutation associated with the classification query lies within the range of matched genes.

Table generation module 220 may act generally to generate hierarchy tables based on the variant matching and ranged matching performed by matching module 210, in response to a classification query.

Below is an example of a matched hierarchy table generated by table generation module 220, based on the received hierarchy table received from genetic database 130 via receiving module 200 and the matching mutations determined by matching module 210, in response to the classification query, according to various embodiments of the present invention presented above:

TABLE 2

| Gene | Annotation | Alteration Type | Range | Level | Priority | Classification | Pubmed |
|---|---|---|---|---|---|---|---|
| BRAF | D594G | | | Variant | 1 | Pathogenic | 15703 . . . |
| BRAF | N5815 | | | Variant | 1 | Pathogenic | 19333 . . . |
| BRAF | V600E | | | Variant | 1 | Pathogenic | 20197 . . . |
| BRAF | POS | missense mutation . . . | 600 | Codon | 2 | Likely | 20197 . . . |
| | | | | | | Pathogenic | |
| BRAF | Catalytic | missense mutation . . . | 574-581 | Highly conserved | 3 | VUS | 15035 . . . |
| | loop | | | region | | | |
| BRAF | A-loop | missense mutation . . . | 597-601 | Highly conserved | 3 | Likely | 15035 . . . |
| | | | | region | | Pathogenic | |
| BRAF | DFE | missense mutation . . . | 594-596 | Highly conserved | 3 | Likely | 20141 . . . |
| | | | | region | | Pathogenic | |
| BRAF | P-loop | missense mutation . . . | 464-469 | Highly conserved | 3 | Likely | 15035 . . . |
| | | | | region | | Pathogenic | |
| BRAF | Protein | missense mutation . . . | 457-717 | Domain | 5 | VUS | uniprot |
| | kinase | | | | | | |

The matched hierarchy table (Table 2) represents a subset of a larger set of tabular data received by genetic database 130, described above. Table 2 contains information form publications, for example, from Pubmed and the corresponding publication reference numbers. Table 2 also contains “Hierarchy Levels” that correspond to the priority of the match and represent the area of specificity of the matching gene in the table to the received mutation in the query. It should be appreciated by those in the art that table generated by table generation module 220 includes results from variant matching and ranged matching. This may be advantageous as tables generated only based on variant matching may return no results. Ranged matching may allow the selection of the closest match of the non-exact ranged matches as oppose to other techniques known in the art having no returned matches.

Classification module 230 acts generally to determine the closest matching mutation in the generated table of matched variants, for example, the hierarchy table generated by table generation module 220, to the received mutation. Classification module 230 may also assign a classification to the mutation associated with the classification query, where the assigned classification is the same as the classification associated with the closest matched mutation.

After the variant matching and range matching, is correlated and the classification associated with the closest matched entry, associated with the lowest priority level number, of the highest priority is assigned to the mutation associated with the classification query. Classification module 230 may communicate the resulting closest match to the user device 120. Table 3 is an exemplary representation of the closest matching entries:

TABLE 3

| | | HT Level | | | |
|---|---|---|---|---|---|
| Gene | Alteration | Matches | Priority | Classification | PubMed |
| BRAF | V600E | Variant | 1 | Pathogenic | 20197 . . . |
| BRAF | Pos | Codon | 2 | Likely Pathogenic | 20197 . . . |
| BRAF | A-Loop | Highly | 3 | Likely Pathogenic | 15035 . . . |
| | | Conserved | | | |
| | | Region | | | |

Classification module 230 may assign a classification, pathogenic, associated with the highest priority, 1, where the classification of the mutation associated with the classification query is the same as the mutation associated with the highest priority. In various embodiments, if there are multiple matches with the same priority level, for example, the matches with priority level 3 in Table 2 above, the closest matched entry may be based on the entry with the highest classification based on the following order: pathogenic, benign, likely pathogenic, likely benign, variant of unknown classification.

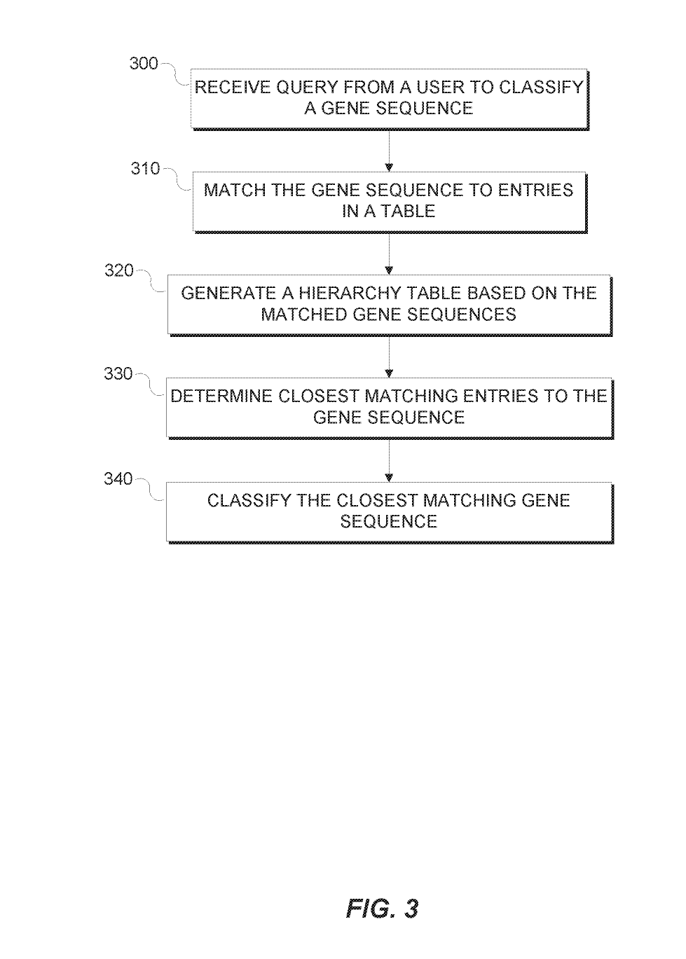

FIG. 3 is a flowchart depicting operational steps of genetic classification application 111, on server 110 within the data processing environment 100 of FIG. 1, in accordance with an embodiment of the present invention.

Receiving module 200 receives a classification query from a user, via user device 120 (block 300). The request may contain a mutation where the pathogenicity of the mutation associated with the classification query is unknown. For example, receiving module 200 may receive a mutation and an associated query for classification of the mutation. The mutation may be from a genetic sample, where the sequence is determined by any method known in the art. In various embodiments, the mutation may be from literature where the classification is unknown. Receiving module 200 may communicate the received mutation to matching module 210.

Matching module 210 receives a mutation associated with a classification query from receiving module 200. Matching module 210 matches the received mutation to entries in a hierarchy table (block 310). The table of entries may comprise ingested and indexed data from a data store, for example, genetic database 130. In various embodiments, matching module 210 uses variant matching and ranged matching to identify matches to the variant within the received hierarchy table. In various embodiments, if a match is found during variant matching, ranged matching is not performed, however, if no results are returned after variant matching ranged matching is performed. Ranged matching may return multiple results, for example, matching module 210 may search gene data, or table entries, and match the received mutation to gene entries, for example, several BRAF mutations are matched to the received mutation along with the associated ingested data with each entry. Matching module 210 may communicate the matched mutations and the mutation associated with the classification query to table generation module 220.

Table generation module 220 may act to generate a matched hierarchy table of matched mutations received from matching module 210. Table generation module 220 communicates the matched hierarchy table to classification module 230. For example, table generation module 220 may receive the matched BRAF entries and associated data from matching module 210 and generate a hierarchy table, for example, Table 2. Table generation module 220 may communicate the generated matched hierarchy table to classification module 230.

Classification module 230 determines the closest matching entry to the received mutation (block 330). In various embodiments, Classification module 230 determines the closest match to the mutation associated with the classification query based on a genetic entry having a name, description, and range matching the name, description, and range of the mutation associated with the classification query. In various embodiments, Classification module 230 determines the closest match to the mutation associated with the classification query based on an amino acid change, nucleotide change, codon, highly conserved region, protein-protein interaction region and protein domain. In various embodiments, classification module 230 may determine multiple genetic entries that are below a threshold in similarity to the mutation associated with the classification query. The multiple genetic entries may have different priority numbers. In various embodiments, classification module 230 assigns a classification to the received mutation, associated with the classification query, based on the classification of the closet matching mutation and the associated lowest priority number of the matched mutations (block 340). In various embodiments, the classifications include a benign, likely benign, pathogenic, likely pathogenic, and variants of unknown significance (VUS). For example, as seen in Table 3 above, the matched BRAF gene entry with the lowest priority number (highest priority) is classified as pathogenic, therefore the mutation associated with the classification query may be classified as pathogenic.

FIG. 4 is a flowchart depicting operational steps of classification module 230 within genetic classification application 111, on server 110 within the data processing environment 100 of FIG. 1, in accordance with an embodiment of the present invention.

Classification module 230 determines the closest mutation match to the mutation associated with the gene classification query (block 400), wherein the classifications is determined to be benign, likely benign, pathogenic, likely pathogenic, or Variant of Unknown Significance and applied to the mutation associated with gene classification query (block 410), based on the determined closest matched mutations determined (block 400).

If the mutation is classified as benign or likely benign (block 420 “YES” branch), the gene is reported with associated classification (block 450). If the gene is classified as pathogenic, (block 430 “YES” branch), the gene is reported for further study (block 460) and pathway analysis is performed (block 480). If the gene is classified as a variant of unknown significance (block 440 “YES” branch), the gene is reported for further study (block 470).

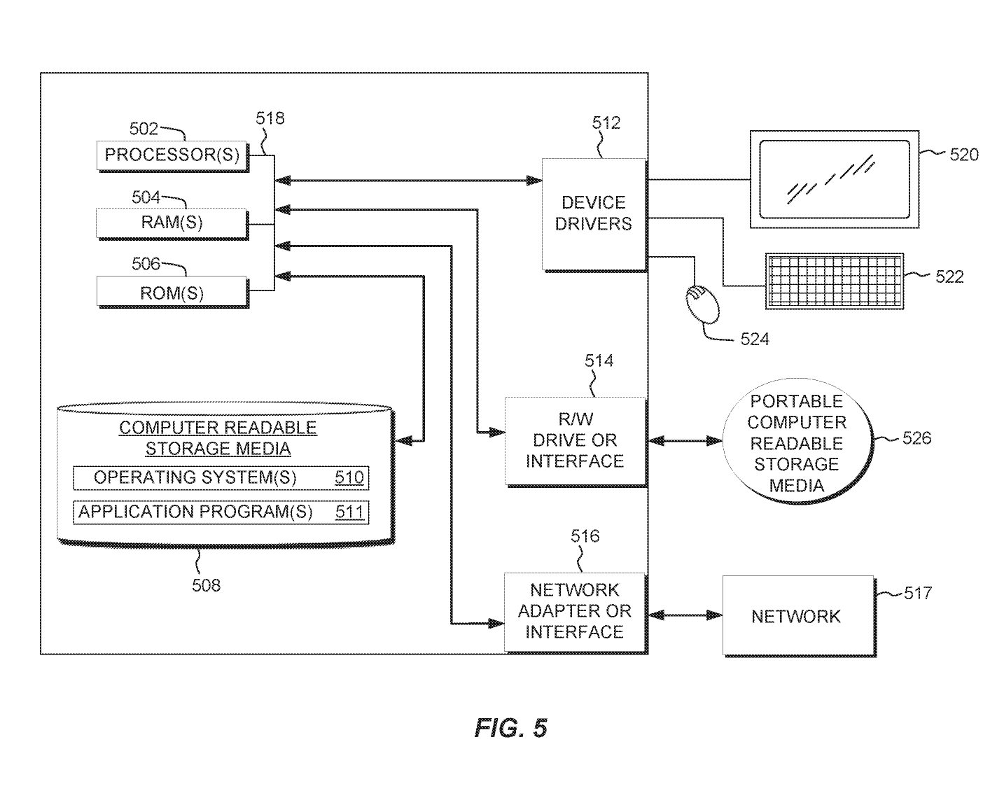

FIG. 5 depicts a block diagram of components of server 110 and other components of the distributed data processing environment of FIG. 1, for example, user device 120 and genetic database 130, in accordance with an embodiment of the present invention. It should be appreciated that FIG. 5 provides only an illustration of one implementation and does not imply any limitations with regard to the environments in which different embodiments may be implemented. Many modifications to the depicted environment may be made.

Server 110 may include one or more processors 502, one or more computer-readable RAMs 504, one or more computer-readable ROMs 506, one or more computer readable storage media 508, device drivers 512, read/write drive or interface 514, network adapter or interface 516, all interconnected over a communications fabric 518. Communications fabric 518 may be implemented with any architecture designed for passing data and/or control information between processors (such as microprocessors, communications and network processors, etc.), system memory, peripheral devices, and any other hardware components within a system.

One or more operating systems 510, and one or more application programs 511, for example, genetic classification application 111, are stored on one or more of the computer readable storage media 508 for execution by one or more of the processors 502 via one or more of the respective RAMs 504 (which typically include cache memory). In the illustrated embodiment, each of the computer readable storage media 508 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Server 110 may also include an R/W drive or interface 514 to read from and write to one or more portable computer readable storage media 526. Application programs 511 on server 110 may be stored on one or more of the portable computer readable storage media 526, read via the respective R/W drive or interface 514 and loaded into the respective computer readable storage media 508.

Server 110 may also include a network adapter or interface 516, such as a TCP/IP adapter card or wireless communication adapter (such as a 4G wireless communication adapter using OFDMA technology) for connection to a network 517. Application programs 511 on Server 110 may be downloaded to the computing device from an external computer or external storage device via a network (for example, the Internet, a local area network or other wide area network or wireless network) and network adapter or interface 516. From the network adapter or interface 516, the programs may be loaded onto computer readable storage media 508. The network may comprise copper wires, optical fibers, wireless transmission, routers, firewalls, switches, gateway computers and/or edge servers.

Server 110 may also include a display screen 520, a keyboard or keypad 522, and a computer mouse or touchpad 524. Device drivers 512 interface to display screen 520 for imaging, to keyboard or keypad 522, to computer mouse or touchpad 524, and/or to display screen 520 for pressure sensing of alphanumeric character entry and user selections. The device drivers 512, R/W drive or interface 514 and network adapter or interface 516 may comprise hardware and software (stored on computer readable storage media 508 and/or ROM 506).

In various embodiments try and identify post-solution activity, significantly more, improvements to computer, improvements to computer related technology, improvements to tech (although not sure what the last one really means

In various embodiments, unknown mutations are automatically classified mutations using a table of knowledge in the format of a hierarchical classification table, without need for manual curation by genomics domain subject matter experts one at a time. A query from a user to classify a mutation is received. The mutation to one or more entries in the table of known gene classifications are matched based on a name, a description, or a range of the mutation, or a combination thereof. One or more entries are determined to be the closest matched entry to the mutation. The mutation is classified using the classification of the closest matched entry.

In various embodiments, determining which of the one or more entries is a closest match entry to the mutation comprises selecting as the closest matched entry an entry having a name, a description, and a range matching the name, the description, and the range of the mutation.

In various embodiments, determining which of the one or more entries is a closest match entry to the mutation comprises selecting as the closest matched entry, either (1) a first entry having a name and a description matching the name and the description of the mutation; or (2) a second entry having a name and a range matching the name and the range of the mutation.

In various embodiments, selecting as the closest matched entry comprises, selecting the highest priority entry in the database.

In various embodiments, the table of known gene classifications comprises columns including a gene name column, a gene annotation column, a gene range column, a gene hierarchy priority column, and a gene classification column.

In various embodiments, the classifications in the table of known gene classifications comprise benign classifications, likely benign classifications, pathogenic classifications, likely pathogenic classifications, and variants of unknown significance (VUS) classifications.

In various embodiments, the hierarchical mutation classification table for known gene mutation classifications comprises a plurality of hierarchical levels each having an associated level name and an associated annotation, the annotation being derived from unstructured natural language text documents or literature.

It should be appreciated that the invention presented above may be conducted within user device 120. For example, user device 120 may be capable of genetic sequencing, ingesting publications, and performing the functions of genetic classification application 111. For example, user device 120 may, after sequencing genetic material, for example a biopsy, obtain the mutation in the genetic material, using any known method in the art, match the obtained mutation with genetic data in memory, match the obtained mutation with the genetic data, and display the closest matching sequence and corresponding classification.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

What is claimed is:

1. A method for classifying mutations using a table of known classifications generated according to a hierarchical mutation classification table without need for manual curation by genomics domain subject matter experts (SMEs), comprising:
receiving a query from a user to classify a mutation;
matching the mutation to one or more entries in the table of known mutation classifications based on a set of attributes;
determining which of the one or more entries is a closest matched entry to the mutation; and
classifying the mutation using the classification of the closest matched entry.

2. The method of claim 1, wherein the set of attributes further comprises: a name; a description; or a range of a gene sequence; or a combination thereof.

3. The method of claim 1, wherein the set of attributes further comprises: an amino acid change value; a nucleotide change value; codon value; highly conserved region value; protein-protein interaction region value; and a protein domain value.

4. The method of claim 1, wherein determining which of the one or more entries is a closest matched entry to the mutation comprises:
selecting as the closest matched entry, an entry having a name, a description, and a range matching the name, the description, and the range of the mutation.

5. The method of claim 1, wherein determining which of the one or more entries is a closest matched entry to the mutation comprises:
selecting as the closest matched entry, either
a first entry having a name and a description matching the name and the description of a gene sequence; or
a second entry having a name and a range matching the name and the range of the gene sequence.

6. The method of claim 5, wherein selecting as the closest matched entry comprises:
selecting from the first entry or the second entry an entry having a highest hierarchy priority value.

7. The method of claim 1, wherein the table of known mutation classifications comprises columns including a gene name column, a annotation column, a gene range column, a gene hierarchy priority column, and a gene classification column.

8. The method of claim 1, wherein classifications in the table of known gene classifications comprise: a benign classification, a likely benign classification, a pathogenic classification, a likely pathogenic classification, and a variants of unknown significance (VUS) classification.

9. The method of claim 1, wherein the hierarchical mutation classification table for known gene mutation classifications comprises:
a plurality of hierarchical levels each having an associated level name and an associated genetic variation location description, the genetic variation location description being derived from unstructured natural language text documents.

10. A computer program product for classifying mutations using a table of known gene classifications generated according to a hierarchical mutation classification table for known gene mutation classifications without need for manual curation by genomics domain subject matter experts (SMEs), the computer program product comprising:
one or more computer-readable storage media and program instructions stored on the one or more computer-readable storage media, the program instructions comprising:
instructions to receive a query from a user to classify a mutation;
instructions to match the mutation to one or more entries in the table of known mutation classifications based on a set of attributes;
instructions to determine which of the one or more entries is a closest matched entry to the mutation; and
instructions to classify the mutation using the classification of the closest matched entry.

11. The computer program product of claim 10, wherein the set of attributes further comprises: a name; a description; or a range of a gene sequence; or a combination thereof.

12. The computer program product of claim 10, wherein the set of attributes further comprises: an amino acid change value; a nucleotide change value; codon value; highly conserved region value; protein-protein interaction region value; and a protein domain value.

13. The computer program product of claim 10, wherein instructions to determine which of the one or more entries is a closest matched entry to the mutation comprises:
instructions to select as the closest matched entry, an entry having a name, a description, and a range matching the name, the description, and the range of the mutation.

14. The computer program product of claim 10, wherein instructions to determine which of the one or more entries is a closest matched entry to the mutation comprises:
instructions to select as the closest matched entry, either
a first entry having a name and a description matching the name and the description of a gene sequence; or
a second entry having a name and a range matching the name and the range of the gene sequence.

15. The computer program product of claim 14, wherein instructions to select as the closest matched entry further comprises:
instructions to select from the first entry or the second entry an entry having a highest hierarchy priority value.

16. The computer program product of claim 10, wherein the table of known mutation classifications comprises columns including: a gene name column, an annotation column, a gene range column, a gene hierarchy priority column, and a gene classification column.

17. The computer program product of claim 10, wherein classifications in the table of known gene classifications comprise: a benign classification, a likely benign classification, a pathogenic classification, a likely pathogenic classification, and a variants of unknown significance (VUS) classification.

18. The computer program product of claim 10, wherein the hierarchical mutation classification table for known gene mutation classifications comprises:
a plurality of hierarchical levels each having an associated level name and an associated genetic variation location description, the genetic variation location description being derived from unstructured natural language text documents.

19. A computer system for classifying unknown mutations using a table of known gene classifications generated according to a hierarchical mutation classification table for known gene mutation classifications without need for manual curation by genomics domain subject matter experts (SMEs), the computer system comprising:
one or more computer processors;
one or more computer-readable storage media;
program instructions stored on the computer-readable storage media for execution by at least one of the one or more computer processors, the program instructions comprising:
instructions to receive a query from a user to classify a mutation;
instructions to match the mutation to one or more entries in the table of known mutation classifications based on a set of attributes;
instructions to determine which of the one or more entries is a closest matched entry to the mutation; and
instructions to classify the mutation using the classification of the closest matched entry.

20. The computer system of claim 19, wherein determining which of the one or more entries is a closest matched entry to the mutation comprises:
instructions to select as the closest matched entry an entry having a name, a description, and a range matching the name, the description, and the range of the mutation.
